(19) United States
(12) Patent Application Publication
(10) Pub. No.: US 2010/0003481 A1
(43) Pub. Date: Jan. 7, 2010

(54) DISPLAY SUBSTRATE FOR EMBEDDING PIXEL-CONTROLLING ELEMENTS

(76) Inventors: Masahito Nakabayashi, Saitama-shi (JP); Tatsuo Fukuda, Saitama-shi (JP); Yasunori Karasawa, Warabi-shi (JP); Naofumi Izumi, Itabashi-ku (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/448,150

(22) PCT Filed: Dec. 20, 2007
(86) PCT No.: PCT/JP2007/075239

§ 371 Date: Jun. 10, 2009

(30) Foreign Application Priority Data
Dec. 25, 2006 (JP) 2006-347879

(51) Int. Cl. B32B 17/10; B32B 7/02

(52) U.S. Cl. 428/214; 428/339

(57) ABSTRACT

(1) A display substrate for embedding pixel-controlling elements comprising an adhesive layer and a thermoplastic film having a thickness of 50 to 500 μm which are laminated successively to a base plate successively in this order, wherein a storage modulus (E′) of the adhesive layer is 1.0×10⁶ Pa or greater at 100 to 200° C., and (2) a display substrate for embedding pixel-controlling elements comprising an adhesive layer, a gas barrier layer and a thermoplastic film having a thickness of 50 to 500 pm which are laminated to a base plate successively in this order, wherein a storage modulus (E′) of the adhesive layer is 1.0×10⁴ Pa or greater at 100 to 200° C., and a thickness of the gas barrier layer is 25 nm or greater. A pixel-controlling substrate in which pixel-controlling elements for controlling individual pixels for a display are embedded can be prepared with excellent quality using the display substrate.

### TECHNICAL FIELD

The present invention relates to a display substrate for embedding pixel-controlling elements and, more particularly, to a display substrate for embedding pixel-controlling elements used for preparing a pixel-controlling substrate in which pixel-controlling elements for controlling individual pixels for a display are embedded with excellent quality.

### BACKGROUND ART

In conventional planar displays, a minute electronic device such as a thin film transistor (TFT) is formed in the vicinity of each pixel to control the pixel. However, the process for forming the pixel-controlling elements requires many steps and is complicated, and it is inevitable that the cost is increased. Therefore, technology in which minute chips of crystalline silicon circuits are fixed on a display substrate in accordance with a printing technology or the like to decrease the cost, is disclosed (for example, refer to Patent Reference 1).

As this technology, a process in which a thermoplastic organic material is used and pixel-controlling elements are embedded into a display substrate using a heated press, is disclosed. However, it is known that the pixel-controlling elements are displaced from the correct positions depending on the condition of the embedding. Although the displacement can be decreased by decreasing the thickness of the organic material, the organic material tends to be curled or deformed due to the decrease in the thickness, and problems arise in that the arrangement of the pixel-controlling elements becomes difficult and that the sufficiently accurate positioning cannot be achieved in the step of wiring and the step of preparing electrodes after the pixel-controlling elements have been embedded.

To overcome the above problems, the present inventors prepared a display substrate for embedding pixel-controlling elements in which a thermoplastic film having a specific thickness is laminated to a base plate such as a glass plate via an adhesive layer. When the display substrate for embedding pixel-controlling elements described above is used, the substrate is degassed by heating under a reduced the pressure at a temperature somewhat lower than the glass transition temperature of the thermoplastic film which is a member of the substrate (hereinafter, referred to as the degassing treatment, occasionally) and, thereafter, the substrate is heated at a temperature of the glass transition temperature of the thermoplastic film or higher so that the pixel-controlling elements are embedded into the substrate. However, when the above display substrate for embedding pixel-controlling elements is used, a problem arises in that undesirable phenomena such as foaming and swelling take place when the substrate is heated at the temperature of the degassing treatment, and the degassing treatment cannot be conducted properly.

[Patent Reference 1] Japanese Patent Application Laid-Open No. 2003-248436

### DISCLOSURE OF THE INVENTION

### [Problems to be Overcome by the Invention]

Under the above circumstances, the present invention has an object of providing a display substrate for embedding pixel-controlling elements which comprises a thermoplastic film having a specific thickness and a base plate such as glass plate as the constituting members and exhibits excellent quality.

Specifically, the present invention has an object of realizing a display-substrate for embedding pixel-controlling elements which exhibits the property of preventing foaming and swelling of the thermoplastic film when the substrate is heated at the temperature of the degassing treatment before the pixel-controlling-elements are embedded (hereinafter, this property will be referred to as the blister resistance).

### [Means for Overcoming the Problems]

As the result of intensive studies by the present inventors to achieve the above object, it was found that, in a display substrate for embedding pixel-controlling elements in which a thermoplastic film having a specific thickness, an adhesive layer and a base plate were laminated successively in this order, excellent blister resistance could be exhibited when a material exhibiting a storage modulus of a specific value or greater at 100 to 200° C. was used for the adhesive layer.

It was also found that the excellent blister resistance could be exhibited also by forming a gas barrier layer between the thermoplastic film and the adhesive layer and, as the result, the storage modulus of the adhesive layer at 100 to 200° C. could be decreased from the specific value in the above.

It was further found that adhesion of the thermoplastic film with the adhesive layer could be enhanced by treating the thermoplastic film by corona discharge or by plasma discharge on the face to be brought into contact with the adhesive layer, that the adhesion between the adhesive layer and the base plate was enhanced when the adhesive layer comprises a silane coupling agent, and that, due to these effects, a display substrate for embedding pixel-controlling elements, which enabled to prepare the pixel-controlling substrate having embedded pixel-controlling elements for controlling individual elements, with excellent quality, could be obtained.

The present invention provides:

[1] A display substrate for embedding pixel-controlling elements comprising an adhesive layer and a thermoplastic film having a thickness of 50 to 500 μm which are laminated to a base plate successively in this order, wherein a storage modulus (E′) of the adhesive layer is 1.0×10⁶ Pa or greater at 100 to 200° C. as measured in accordance with Japanese Industrial Standard K 7244-4;
[2] A display substrate for embedding pixel-controlling elements comprising an adhesive layer, a gas barrier layer and a thermoplastic film having a thickness of 50 to 500 μm which are laminated to a base plate successively in this order, wherein a storage modulus (E′) of the adhesive layer is 1.0×10⁴ Pa or greater at 100 to 200° C. as measured in accordance with Japanese Industrial Standard K 7244-4, and a thickness of the gas barrier layer is 25 nm or greater;
[3] The display substrate for embedding pixel-controlling elements described in [2], wherein the gas barrier layer is an oxide film, a nitride film or an oxide-nitride film of silicon;
[4] The display substrate for embedding pixel-controlling elements described in any one of [1] to [3], wherein the adhesive layer is a pressure sensitive adhesive layer or a cured layer of a pressure sensitive adhesive curable with energy;
[5] The display substrate for embedding pixel-controlling elements described in any one of [1] to [4], wherein a thickness of the adhesive layer is 10 to 50 μm;
[6] The display substrate for embedding pixel-controlling elements described in any one of [1] to [5], wherein the adhesive layer comprises a silane coupling agent;
[7] The display substrate for embedding pixel-controlling elements described in any one of [1] to [6], wherein a raw material for the thermoplastic film is a polymer having an alicyclic structure; and
[8] The display substrate for embedding pixel-controlling elements described any one of [1] to [7], wherein the thermoplastic film has been treated by corona discharge or plasma discharge on a face at a side of the adhesive layer.

### THE EFFECT OF THE INVENTION

In accordance with the present invention, a display substrate for embedding pixel-controlling elements which enables to prepare a pixel-controlling substrate having embedded pixel-controlling elements for controlling individual elements for a display with excellent quality, can be provided.

### THE MOST PREFERRED EMBODIMENT TO CARRY OUT THE INVENTION

The display substrate for embedding pixel-controlling elements of the present invention (hereinafter, referred to as the display substrate for embedding, occasionally) has two aspects, i.e., Display substrate for embedding I and Display substrate for embedding II.

Display substrate for embedding I of the present invention is a display substrate for embedding pixel-controlling elements comprising an adhesive layer and a thermoplastic film having a thickness of 50 to 500 μm which are laminated to a base plate successively in this order, and Display substrate for embedding II of the present invention is a display substrate for embedding pixel-controlling elements comprising an adhesive layer, a gas barrier layer and a thermoplastic film having a thickness of 50 to 500 μm which are laminated to a base plate successively in this order.

The base plate in the display substrate for embedding of the present invention is not particularly limited, and a glass plate conventionally used as the substrate for displays such as plates of soda lime glass, glass containing barium and strontium, aluminosilicate glass, lead glass, borosilicate glass, barium borosilicate glass and quartz can be used. A plastic base plate can also be used as the base plate. Examples of the plastic base plate include plates of fumaric diester-based resins and epoxy resins. A base plate having transparency suitable for optical applications, a high glass transition temperature and a small coefficient of linear expansion is preferable.

The thickness of the base plate is suitably selected in accordance with the application. The thickness is, in general, about 0.1 to 5 mm and preferably 0.2 to 3 mm.

Display substrate for embedding I of the present invention will be described specifically in the following.

Display substrate for embedding I of the present invention has a structure such that an adhesive layer and a thermoplastic film having a thickness of 50 to 500 μm are laminated to the base plate successively in this order.

In Display substrate for embedding I of the present invention, it is required that the adhesive layer formed on the base plate described above have a storage modulus (E′) of 1.0×10⁶ Pa or greater at 100 to 200° C. When the adhesive layer has a storage modulus described above, it is possible that the display substrate for embedding pixel-controlling elements exhibiting excellent blister resistance is provided.

The upper limit of the storage modulus (E′) of the adhesive layer at 100 to 200° C. is, in general, about 1.0×10¹¹ Pa although the upper limit of the storage modulus is not particularly restricted.

The method for measurement of the storage modulus will described below.

For forming the adhesive layer, it is preferable that (1) a pressure sensitive adhesive or (2) a pressure sensitive adhesive curable with energy is used. Between these adhesives, the pressure sensitive adhesive curable with energy of (2) is more preferable. When any of these adhesives is used, it is necessary that the adhesive forms an adhesive layer exhibiting transparency suitable for optical applications.

As the pressure sensitive adhesive curable with energy, a pressure sensitive adhesive curable with heat or a pressure sensitive adhesive curable with energy ray can be used. Examples of the energy ray include ultraviolet light and electron ray.

When the pressure sensitive adhesive curable with energy is used, the adhesive layer can be formed by curing by application of energy after the construction of the display substrate for embedding pixel-controlling elements shown in the present invention is formed by lamination. The adhesive layer formed as described above will be referred to as “the adhesive layer cured with heat” or “the adhesive layer cured with energy ray” in accordance with the applied energy, occasionally in the present specification. When the pressure sensitive adhesive curable with energy is used, it is also possible that the face coated with the adhesive is cured in advance by application of energy and, thereafter, the construction of the display substrate for embedding pixel-controlling elements shown in the present invention is formed by lamination. The adhesive layer formed as described above will be occasionally referred to as “the pressure sensitive adhesive layer” in the present specification, including the case where the pressure sensitive adhesive of (1) is used.

By using the pressure sensitive adhesive curable with energy described above, the thermoplastic film can be fixed to the base plate such as a glass plate with excellent workability, and a great modulus can be maintained at high temperatures. It is preferable that the adhesive is in a sheet form. The thermoplastic film can be fixed with a great accuracy of the thickness and excellent workability by forming the adhesive into a sheet form in advance.

Examples of the pressure sensitive adhesive of (1) include acrylic pressure sensitive adhesives, silicone-based pressure sensitive adhesives and rubber-based pressure sensitive adhesives. Acrylic pressure sensitive adhesives are preferable from the standpoint of weatherability and optical applications.

As the acrylic pressure sensitive adhesive, for example, pressure sensitive adhesives comprising a (meth)acrylic ester copolymer and a crosslinking agent can be used.

Preferable examples of the (meth)acrylic ester copolymer include copolymers of a (meth)acrylic acid ester in which the alkyl group in the ester portion has 1 to 20 carbon atoms, a monomer having a functional group having active hydrogen and other monomers which are used where desired.

Examples of the (meth)acrylic acid ester in which the alkyl group in the ester portion has 1 to 20 carbon atoms include methyl (meth)acrylate, ethyl (meth)acrylate, propyl (meth)acrylate, n-butyl (meth)acrylate, s-butyl (meth)acrylate, t-butyl (meth)acrylate, pentyl (meth)acrylate, hexyl (meth)acrylate, cyclohexyl (meth)acrylate, 2-ethylhexyl (meth)acrylate, n-octyl (meth)acrylate, isooctyl (meth)acrylate, decyl (meth)acrylate, dodecyl (meth)acrylate, myristyl (meth)acrylate, palmityl (meth)acrylate and stearyl (meth)acrylate. The (meth)acrylic ester may be used singly or in combination of two or more.

Examples of the monomer having a functional group having active hydrogen include hydroxyalkyl (meth)acrylate such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate and 4-hydroxybutyl (meth)acrylate; monoalkylaminoalkyl (meth)acrylates such as monomethylaminoethyl (meth)acrylate, monoethylaminoethyl (meth)acrylate, monomethylamino-propyl (meth)acrylate and monoethylaminopropyl (meth)acrylate; and ethylenically unsaturated carboxylic acids such as acrylic acid, methacrylic acid, crotonic acid, maleic acid, itaconic acid and citraconic acid. The above monomer may be used singly or in combination of two or more.

Examples of the other monomer which are used where desired include vinyl esters such as vinyl acetate and vinyl propionate; olefins such as ethylene, propylene and isobutylene; halogenated olefins such as vinyl chloride and vinylidene chloride; styrene-based monomers such as styrene and a-methylstyrene; diene-based monomers such as butadiene, isoprene and chloroprene; nitrile-based monomers such as acrylonitrile and methacrylonitrile; and acrylamides such as acrylamide, N-methyl-acrylamide and N,N-dimethylacrylamide. The above monomer may be used singly or in combination of two or more.

In the acrylic pressure sensitive adhesive, the copolymer form of the (meth)acrylic ester copolymer used as the resin component is not particularly limited and may be any of random, block and graft copolymers. It is preferable that the molecular weight is in the range of 500,000 to 2,000,000 expressed as the weight-average molecular weight.

The weight-average molecular weight is the value obtained in accordance with the gel permeation chromatography (GPC) and expressed as the value of the corresponding polystyrene. The method of the measurement will be specifically described below.

In the present invention, the (meth)acrylic ester copolymer may be used singly or in combination of two or more.

The crosslinking agent used in the acrylic pressure sensitive adhesive is not particularly limited as long as the adhesive exhibits transparency suitable for optical applications, and a desired crosslinking agent can be suitably selected from crosslinking agents conventionally used as the crosslinking agent for acrylic pressure sensitive adhesives such as polyisocyanate compounds, epoxy resins, melamine resins, urea resins, dialdehydes, methylol polymers, metal chelate compounds, metal alkoxides and metal salts. Among the above agents, aliphatic polyisocyanates, alicyclic polyisocyanates, epoxy resins and metal chelate compounds are preferable from the standpoint of the excellent resistance to yellowing.

In the present invention, the crosslinking agent may be used singly or in combination of two or more. The amount is, in general, in the range of 0.01 to 20 parts by mass and preferably in the range of 0.1 to 10 parts by mass per 100 parts by mass of the (meth)acrylic ester copolymer although the amount may be different depending on the type of the crosslinking agent.

To the acrylic pressure sensitive adhesive, tackifiers, antioxidants, ultraviolet light absorbents, light stabilizers, softeners, silane coupling agents and fillers may be added, where desired. It is preferable that a silane coupling agent is added since adhesion with the base plate is enhanced.

As the pressure sensitive adhesive curable with energy of (2), acrylic pressure sensitive adhesives curable with energy are preferable from the standpoint of weatherability and application to the optical field.

Examples of the acrylic pressure sensitive adhesive curable with energy include (a) adhesives comprising a pressure sensitive adhesive acrylic polymer, at least one of a polymerizable oligomer curable with energy and a polymerizable monomer curable with energy and, where desired, a polymerization initiator and (b) adhesives comprising a pressure sensitive adhesive acrylic polymer in which a functional group curable with energy having a polymerizable double bond into the side chain is introduced (hereinafter, referred to as “a copolymer curable with energy”, occasionally) and, where desired, a polymerization initiator.

In the adhesive of (a), preferable examples of the pressure sensitive adhesive acrylic polymer include copolymers of an acrylic ester in which the alkyl group in the ester portion has 1 to 20 carbon atoms, a monomer having a functional group having active hydrogen which is used where desired and other monomers.

Examples of the compounds described above include the compounds described as the examples of the corresponding compounds in the description of the acrylic pressure sensitive adhesive of (1).

Examples of the polymerizable oligomer curable with energy include polyester acrylate-based polymerizable oligomers, epoxy acrylate-based polymerizable oligomers, urethane acrylate-based polymerizable oligomers, polyether acrylate-based polymerizable oligomers, polybutadiene acrylate-based polymerizable oligomers and silicone acrylate-based polymerizable oligomers.

The polymerizable oligomer may be used singly or in combination of two or more.

Examples of the polymerizable monomer curable with energy include monofunctional acrylates such as cyclohexyl (meth)acrylate, 2-ethylhexyl (meth)acrylate, lauryl (meth)acrylate, stearyl (meth)acrylate and isobornyl (meth)acrylate; and polyfunctional acrylates such as 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, neopentyl glycol hydroxypivalate di(meth)acrylate, dicyclopentanyl di(meth)acrylate, dicyclopentenyl di(meth)acrylate modified with caprolactone, phosphorus di(meth)acrylate modified with ethylene oxide, cyclohexyl di(meth)-acrylate. modified with allyl group, isocyanurate di(meth)acrylate, trimethylolpropane tri(meth)acrylate, dipentaerythritol tri(meth)acrylate, dipentaerythritol tri(meth)acrylate modified with propionic acid, pentaerythritol tri(meth)acrylate, trimethylolpropane tri(meth)acrylate modified with propylene oxide, tris(acryloxyethyl) isocyanurate, dipentaerythritol penta(meth)acrylate modified with propionic acid, dipentaerythritol hexa(meth)acrylate and dipentaerythritol hexa(meth)-acrylate modified with caprolactone. The polymerizable monomer may be used singly or in combination of two or more.

As the polymerization initiator which is used where desired, an organic peroxide or an azo-based compound is used when the pressure sensitive adhesive curable with energy is a pressure sensitive adhesive curable with heat. Examples of the organic peroxide include dialkyl peroxides such as di-t-butyl peroxide, t-butyl cumyl peroxide and dicumyl peroxide; diacyl peroxides such as acetyl peroxide, lauroyl peroxide and benzoyl peroxide; ketone peroxides such as methyl ethyl ketone peroxide, cyclohexanone peroxide, 3,3,5-trimethylcyclo-hexanone peroxide and methylcyclohexanone peroxide; peroxyketals such as 1,1-bis(t-butylperoxy)cyclohexane; hydroperoxides such as t-butyl hydroperoxide, cumene hydroperoxide, 1,1,3,3-tetramethylbutyl hydroperoxide, p-menthane hydroperoxide, diisopropylbenzene hydroperoxide and 2,5-dimethylhexane 2,5-dihydroperoxide; and peroxyesters such as t-butyl peroxyacetate, t-butyl peroxy-2-ethylhexanoate, t-butyl peroxybenzoate, t-butyl peroxyisopropyl carbonate and t-butyl peroxy-3,3,5-trimethylhexanoate.

Examples of the azo-based compound include 2,2′-azobis-(4-methoxy-2,4-dimethylvaleronitrile), 2,2′-azobis(2-cyclopropylpropio-nitrile), 2,2′-azobis(2,4-dimethylvaleronitrile), azobisisobutyronitrile, 2,2′-azobis(2-methylbutyronitrile), 1,1′-azobis(cyclohexane-1-carbonitrile), 2-(carbamoylazo)isobutyronitrile and 2-phenylazo-4-methoxy-2,4-dimethylvaleronitrile.

The polymerization initiator may be used singly or in combination of two or more.

When the pressure sensitive adhesive curable with energy is a pressure sensitive adhesive curable with energy ray, in general, the pressure sensitive adhesive is irradiated with ultraviolet light or electron ray. When the pressure sensitive adhesive is irradiated with ultraviolet light, a photopolymerization initiator can be used as the polymerization initiator. Examples of the photopolymerization initiator include benzoin, benzoin methyl ether, benzoin ethyl ether, benzoin isopropyl ether, benzoin n-butyl ether, benzoin isobutyl ether, acetophenone, dimethyl-aminoacetophenone, 2, 2-dimethoxy-2-phenylacetophenone, 2, 2-diethoxy-2-phenylacetophenone, 2-hydroxy-2-methyl- 1-phenylpropan- 1-one, 1-hydroxycyclohexyl phenyl ketone, 2-methyl-1-[4-(methylthio)phenyl]-2-morpholinopropan-1-one, 4-(2-hydroxyethoxy)phenyl 2-(hydroxy-2-propyl) ketone, benzophenone, p-phenylbenzophenone, 4,4′-diethylaminobenzophenone, dichlorobenzophenone, 2-methylanthraquinone, 2-ethyl-anthraquinone, 2-tertiary-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminebenzoic ester and oligo[2-hydroxy-2-methyl-1-[4- (1-propenyl)phenyl]propane]. The above compound may be used singly or in combination of two or more.

In the adhesive of (b), examples of the pressure sensitive adhesive acrylic polymer in which a functional group curable with energy having a polymerizable double bond is introduced into the side chain include compounds obtained by introducing an active point such as —COOH, —NCO, epoxy group, —OH and —NH2 into the polymer chain of the pressure sensitive adhesive acrylic polymer described above in the adhesive of (a), followed by bringing the active point into reaction with a compound having a polymerizable double bond to introduce a functional group curable with energy having a polymerizable double bond into the side chain of the pressure sensitive adhesive acrylic polymer.

For introducing the active point described above into the pressure sensitive adhesive acrylic polymer, a monomer or an oligomer having a functional group such as —COOH, —NCO, epoxy group, —OH and —NH₂ and a polymerizable double bond is made coexist in the reaction system in the production of the pressure sensitive adhesive acrylic polymer described above.

Specifically, in the production of the pressure sensitive adhesive acrylic polymer described above for the adhesive of (a), (meth)acrylic acid or the like is used for introducing —COOH, (meth)acryloxyethyl isocyanate or the like is used for introducing —NCO, glycidyl (meth)acrylate or the like is used for introducing epoxy group, 2-hydroxyethyl (meth)acrylate or 1,6-hexanediol mono(meth)acrylate or the like is used for introducing —OH, and N-methyl(meth)acrylamide or the like is used for introducing —NH₂.

As the compound having a polymerizable double bond which is brought into reaction with the active point, a compound can be suitably selected, for example, from (meth)acryloxyethyl isocyanate, glycidyl (meth)acrylate, pentaerythritol mono(meth)acrylate, dipentaerythritol mono(meth)acrylate and trimethylolpropane mono(meth)acrylate in accordance with the type of the active point.

In the manner described above, the pressure sensitive adhesive acrylic polymer in which a functional group curable with energy having a polymerizable double bond has been introduced into the side chain of the pressure sensitive adhesive acrylic polymer via the active point can be obtained.

As the polymerization initiator which is used where desired, the organic peroxide or the azo-based compound described for the adhesive of (a) can be used when the pressure sensitive adhesive curable with energy is a pressure sensitive adhesive curable with heat, and the photopolymerization initiator described as the example in the description of the adhesive of (a) in the above can be used when the pressure sensitive adhesive curable with energy is a pressure sensitive adhesive curable with energy ray and ultraviolet light is used as the energy ray.

To the pressure sensitive adhesives curable with energy of (a) and (b), where desired, crosslinking agents, tackifiers, antioxidants, ultraviolet light absorbents, light stabilizers, softeners, silane coupling agents and fillers may be added as long as the effect of the present invention is not adversely affected. It is preferable that the silane coupling agent is added since adhesion with the base plate is enhanced.

Examples of the crosslinking agent include polyisocyanate compounds, epoxy resins, melamine resins, urea resins, dialdehydes, methylol polymers, aziridine-based compounds, metal chelate compounds, metal alkoxides and metal salts. Among these compounds, aliphatic polyisocyanates, alicyclic polyisocyanates, epoxy compounds and metal chelate compounds are preferable due to the excellent resistance to yellowing. The crosslinking agent may be used singly or in combination of two or more.

Display substrate for embedding I of the present invention has a structure such that a thermoplastic film, the adhesive layer (which is occasionally described as the pressure sensitive adhesive layer, the adhesive layer cured with heat or the adhesive layer cured with energy ray) and the base plate are laminated successively in this order.

The thickness of the adhesive layer is not particularly limited. The thickness is, in general, 10 to 50 μm and preferably 15 to 40 μm.

As the thermoplastic film described above, films using a macromolecular polymer having an alicyclic structure as the raw material are preferable. Since the macromolecular polymer having an alicyclic structure exhibits excellent heat resistance and chemical resistance, the pixel-controlling substrate can be produced without deformation or decrease in the mechanical strength in the steps of wiring, formation of electrodes and patterning. The macromolecular polymer having an alicyclic structure exhibits excellent optical transparency and isotropy and is most suitable as the material for displays. The above macromolecular polymer having an alicyclic structure exhibits also excellent property for embedding pixel-controlling elements. As the macromolecular polymer having an alicyclic structure described above, polymers having an alicyclic structure in the main chain and/or side chains can be used without any restrictions. When the mechanical strength and the heat resistance are considered, polymers having an alicyclic structure in the main chain are preferable. As the macromolecular polymer having an alicyclic structure, any of macromolecular polymers having a cycloalkane structure and macromolecular polymers having a cycloalkene structure can be used. When the mechanical strength and the heat resistance are considered, macromolecular polymers having a cycloalkane structure are preferable. The alicyclic structure may be any of monocyclic structures, polycyclic structures, condensed polycyclic structures, crosslinked cyclic structures and polycyclic structures as combinations of these structures. The number of carbon atom constituting the cyclic structure is not particularly limited. The number of carbon atoms constituting the cyclic structure is, in general, in the range of 4 to 30, preferably in the range of 5 to 20 and more preferably in the range of 5 to 15 since the balance of properties such as the mechanical strength, the heat resistance and the property for molding is excellent when the number of carbon atom is in the above range. The alicyclic structure may have substituents such as hydrocarbon groups having 1 to 10 carbon atoms and monovalent polar groups such as carboxyl group.

The content of the repeating unit having an alicyclic structure in the alicyclic polymer is suitably selected in accordance with the object of the use. The content is, in general, 30% by weight or greater, preferably 50% by weight or greater and more preferably 70% by weight or greater. The upper limit of the content is 100% by weight. An excessively small content of the repeating unit having an alicyclic structure in the alicyclic polymer is not preferable due to poor heat resistance. The structure of the portion other than the repeating unit having an alicyclic structure in the alicyclic polymer is not limited and can be suitably selected in accordance with the object of the use. The alicyclic polymer may be not only a homopolymer or a copolymer of monomers having an alicyclic structure but also a copolymer of a monomer having alicyclic structure with monomers which are other than the monomer having an alicyclic structure and are copolymerizable with the monomer having an alicyclic structure or a copolymer subjected to a treatment for converting unsaturated bonds into saturated bond such as hydrogenation when the copolymer has the unsaturated bonds.

Examples of the alicyclic polymer include norbornene-based polymers, monocyclic olefin-based polymers, cyclic conjugated diene-based polymers, vinyl-based hydrocarbon polymers and hydrogenation products of these polymers. Among these polymers, norbornene-based polymers, hydrogenation products of norbornene-based polymers, cyclic conjugated diene-based polymers and hydrogenation products of cyclic conjugated diene-based polymers are preferable, and norbornene-based polymers and hydrogenation products of norbornene-based polymers are more preferable.

Examples of the thermoplastic film using the macromolecular polymer having an alicyclic structure as the raw material include commercial products such as ZENOR Film [manufactured by OPTES Co. Ltd.], ARTON FILM [manufactured. by JSR Corporation], APEL [manufactured by MITSUI CHEMICALS Inc.] and TOPAS [manufactured by TICONA Company].

It is necessary that the thickness of the thermoplastic film be in the range of 50 to 500 μm. By using the film having the thickness in the above range, a pixel-controlling substrate suppressing displacement of the pixels from the correct positions can be prepared. It is preferable that the thickness of the thermoplastic film is 50 to 400 μm and more preferably 100 to 300 μm.

The thermoplastic film may be subjected to a surface treatment in accordance with a process such as the oxidation process and the roughening process or a primer treatment on the face to be brought into contact with the adhesive layer so that adhesion with the adhesive layer is enhanced. Examples of the oxidation process include the treatment by corona discharge, the treatment by plasma discharge, the treatment with chromic acid (the wet process), the treatment with flame, the treatment with the heated air and the treatment with ozone and by irradiation with ultraviolet light. Examples of the roughening treatment include the process of sand blasting and the treatment with a solvent. The surface treatment can be suitably selected in accordance with the type of the thermoplastic film. In general, the treatment by corona discharge and the treatment by plasma discharge are preferable from the standpoint of the effect and the operability.

Display substrate for embedding I of the present invention can be prepared, for example, as described in the following.

The face having the releasing treatment of a release sheet of the heavy releasing type is coated with a coating fluid of the pressure sensitive adhesive or a coating fluid of the pressure sensitive adhesive curable with energy described above in accordance with a conventional process such as the knife coating process, the roll coating process, the bar coating process, the blade coating process, the die coating process or the gravure coating process in a manner such that the coating film has the prescribed thickness after being dried, and the formed coating film is dried. On the dried coating film, a release sheet of the light releasing type is laminated in a manner such that the face of the release sheet treated for releasing is brought into contact with the coating film, and a pressure sensitive adhesive or a pressure sensitive adhesive curable with energy in the sheet form having release sheets laminated to both faces is prepared. Where desired, the pressure sensitive adhesive curable with energy may be cured by applying energy in this stage.

Then, the release sheet of the light releasing type is removed from the pressure sensitive adhesive or the pressure sensitive adhesive curable with energy in the sheet form having release sheet laminated to both faces, and the remaining pressure sensitive adhesive or the pressure sensitive adhesive curable with energy is laminated to the thermoplastic film using a rubber roller or the like. From the standpoint of decreasing the number of the production step and the cost, the pressure sensitive adhesive or the pressure sensitive adhesive curable with energy may be directly laminated to the thermoplastic film after the coating fluid is applied and the formed coating film is dried. The coating fluid may be applied directly to the thermoplastic film in place of coating the release sheet of the heavy releasing type with the coating fluid as described above. When the thermoplastic film has been treated by a surface treatment such as the treatment by corona discharge or the treatment by plasma discharge, the lamination is conducted in a manner such that the face having the surface treatment is brought into contact with the adhesive. After the laminate obtained above is cut to a prescribed size, the release sheet of the heavy releasing type is removed, and the obtained laminate is attached to a base plate such as a glass plate or the like.

When the adhesive in the sheet form is the pressure sensitive adhesive or the pressure sensitive adhesive curable with energy to which energy has been applied, Display substrate for embedding I can be directly obtained by laminating the adhesive in the sheet form to the base plate. Occasionally, the adhesive layers formed in various manners as described above will be referred to simply as the pressure sensitive adhesive layer. When the adhesive in the sheet form is a pressure sensitive adhesive curable with energy to which energy has not been applied, Display substrate for embedding I can be obtained by laminating the adhesive to the base plate, followed by curing the adhesive by application of energy. The adhesive layer formed as described above is occasionally referred to as the adhesive layer cured with heat or the adhesive layer cured with energy ray, depending on the applied energy.

When the pressure sensitive adhesive curable with energy is a pressure sensitive adhesive curable with heat, the curing can be conducted by heating at about 50 to 140° C. When the pressure sensitive adhesive curable with energy is a pressure sensitive adhesive curable with energy ray, in general, ultraviolet light or electron ray is used as the energy ray. Ultraviolet light is obtained from a high pressure mercury lamp, a fusion H lamp or xenon lamp. Electron ray is obtained from an electron accelerator. Between these energy rays, ultraviolet light is preferable. The amount of irradiation of the energy ray is suitably selected so that the storage modulus of the cured layer obtained by the curing is within the above range. For example, when ultraviolet light is used, it is preferable that the amount of light is 100 to 500 mJ/cm² and the luminance is 10 to 500 mW/cm² and, when electron ray is used, it is preferable that the amount of ray is about 10 to 1,000 krad.

In Display substrate for embedding I of the present invention, it is preferable that the adhesive layer is the adhesive layer cured with heat or the adhesive layer cured with energy ray since a value of 1.0×10⁶ Pa or greater is required for the storage modulus (E′) of the adhesive layer at 100 to 200° C.

Display substrate for embedding II of the present invention will be described in the following.

Display substrate for embedding II of the present invention has a structure such that an adhesive layer, a gas barrier layer and a thermoplastic film having a thickness of 50 to 500 μm are laminated successively in this order to a base plate.

In Display substrate for embedding II of the present invention, the storage modulus (E′) of the adhesive layer formed on the base plate at 100 to 200° C. may be smaller than the storage modulus of the adhesive layer in Display substrate for embedding I described above since the gas barrier layer is disposed between the adhesive layer and the thermoplastic film unlike Display substrate for embedding I. It is necessary that the storage modulus (E′) of the adhesive layer in Display substrate for embedding II be 1.0×10⁴ Pa or greater. When the adhesive layer has the storage modulus described above, the excellent blister resistance can be exhibited.

The upper limit of the storage modulus (E′) of the adhesive layer at 100 to 200° C. is, in general, about 1.0×10¹¹ Pa although the upper limit of the storage modulus is not particularly restricted. The method of measurement of the storage modulus (E′) will be described below.

As the adhesive layer, three types of the adhesive layer, i.e., the pressure sensitive adhesive layer, the adhesive layer cured with heat and the adhesive layer cured with energy ray, are preferable. Among these adhesive layers, the adhesive layer cured with heat and the adhesive layer cured with energy ray are preferable since the advantages described above for Display substrate for embedding I are exhibited although the pressure sensitive layer is advantageous from the standpoint of economy.

The pressure sensitive adhesive layer, the adhesive layer cured with heat and the adhesive layer cured with energy ray are as described above for Display substrate for embedding I.

In Display substrate for embedding II of the present invention, the thickness of the adhesive layer formed on the base plate is not particularly limited. The thickness is, in general, 10 to 50 μm and preferably 15 to 40 μm.

The thermoplastic film laminated to the adhesive layer via the gas barrier layer is as described above for Display substrate for embedding I.

In Display substrate for embedding II of the present invention, oxide films, nitride films and oxide-nitride films of silicon are preferable as the gas barrier layer disposed between the adhesive layer and the thermoplastic film from the standpoint of the blister resistance. The adhesive strength of the thermoplastic film is increased by disposing the gas barrier layer comprising the above oxide.

It is necessary that the thickness of the gas barrier layer be 25 nm or greater to obtain the sufficient blister resistance. When the thickness is excessively great, the effect of increasing the blister resistance is not exhibited to the degree expected from the thickness, transparency is decreased, and the thickness is economically disadvantageous. It is preferable that the thickness of the gas barrier layer is 30 to 300 nm and more preferably 40 to 200 nm.

The process for forming the gas barrier layer is not particularly limited. The gas barrier layer may be formed on the face of the thermoplastic film at the side to be brought into contact with the adhesive layer by forming an oxide film, a nitride film or an oxide-nitride film of silicon in accordance with a physical vapor phase deposition process (a PVD process) such as the vacuum vapor deposition process, the sputtering process and the ion plating process or a chemical vapor phase deposition process (a CVD process).

Display substrate for embedding II of the present invention can be prepared in accordance with the same process as the process for preparing Display substrate for embedding I except that the thermoplastic film having the gas barrier layer formed on one face is used in place of the thermoplastic film used in the preparation of Display substrate for embedding I. As the adhesive, any of the pressure sensitive adhesive and the pressure sensitive adhesive curable with energy can be used advantageously.

Examples of the silane coupling agent which may be contained in the adhesive layer in Display substrates for embedding I and II of the present invention, where necessary, include triethoxysilane, vinyltris(β-methoxyethoxy)silane, γ-(meth)acryloxypropyltrimethoxysilane, γ-glycidoxypropyltriemethoxysilane, β-(3, 4-epoxycyclohexyl)ethyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyl-trimethoxysilane, γ-chloropropyltrimethoxysilane and γ-acetoacetoxy-propyltrimethoxysilane. Among these compounds, aminosilanes such as γ-aminopropyltriethoxysilane and N-β-(aminoethyl)-γ- aminopropyltrimethoxysilane and epoxy-based compounds such as γ-glycidoxypropyltrimethoxysilane are preferable.

The release sheet of the heavy releasing type and the release sheet of the light releasing type used for preparation of Display substrates for embedding I and II of the present invention are not particularly limited. Examples of the release sheets include release sheets prepared by coating polyolefin films such as polyethylene films and polypropylene films or polyester films such as polyethylene terephthalate films with a releasing agent such as a silicone resin to form a layer of the releasing agent. The thickness of the release sheet is, in general, about 20 to 150 μm.

By using the display substrate for embedding of the present invention, the pixel-controlling substrate in which pixel-controlling elements such as TFT are embedded in the thermoplastic film can be prepared with excellent quality.

In the present invention, the properties of the adhesive layer of the present invention and the resin components constituting the adhesive layer are measured in accordance with the following methods.

(1) Weight-average molecular weight of a resin composition In accordance with the gel permeation chromatography (GPC), the weight-average molecular weight expressed as the weight-average molecular weight of the corresponding polystyrene is obtained under the following condition:

(Condition of the Measurement)

Apparatus of the GPC measurement: HLC-8020 manufactured by TOSOH Corporation

GPC columns (passed in the following order): manufactured by TOSOH Corporation
TSK guard column HXL-H
TSK gel GMHXL (×2)
TSK gel G2000HXL

Solvent for the measurement: tetrahydrofuran

Temperature of the measurement: 40° C.

(2) Storage modulus (E′) of an adhesive layer

(i) When a pressure sensitive adhesive is used as the adhesive in an adhesive layer
The face for releasing of a release sheet is coated with a coating fluid of an adhesive used for forming an adhesive layer in an amount such that the thickness is 25 μm after being dried, and the formed coating layer is dried at 90° C. for 1 minute to form an adhesive layer. To the surface of the formed adhesive layer, an other release sheet is laminated in a manner such that the face for releasing of the other release sheet is brought into contact with the face of the formed adhesive layer. In this manner, an adhesive in the sheet form having a thickness of 25 μm which has release sheets laminated on both faces is prepared. The obtained adhesive in the sheet form is cut into a piece having a length of 30 mm and a width of 2 mm. Using a test piece obtained by removing the release sheets laminated to both faces of the piece obtained by the cutting, the storage modulus (E′) is measured in accordance with the method of Japanese Industrial Standard K 7244-4.

(ii) When a pressure sensitive adhesive curable with energy is used as the adhesive in an adhesive layer
The face for releasing of a release sheet is coated with a coating fluid of an adhesive used for forming an adhesive layer in an amount such that the thickness is 25 μm after being dried, and the formed coating layer is dried at 90° C. for 1 minute to form an adhesive layer. To the surface of the formed adhesive layer, an other release sheet is laminated in a manner such that the face for releasing of the other release sheet is brought into contact with the face of the formed adhesive layer. In this manner, an adhesive in the sheet form having a thickness of 25 μm which has release sheets laminated on both faces is obtained. The obtained adhesive in the sheet form is cured by heating under the same condition as that in the formation of the adhesive layer or by irradiation with energy ray, and a cured adhesive in the sheet form is prepared. The cured adhesive in the sheet form obtained as described above is cut into a piece having a length of 30 mm and a width of 2 mm. Using a test piece obtained by removing the release sheets laminated to both faces of the piece obtained by the cutting, the storage modulus (E′) is measured in accordance with the method of Japanese Industrial Standard K 7244-4. When the adhesive is an adhesive curable with energy ray, it is necessary that a sheet transmitting the energy ray is used as at least one of the two release sheets laminated to both faces of the adhesive, and the energy ray is applied at the side of the release sheet transmitting the energy ray or that, after the release sheet having a smaller releasing force between the two release sheets is removed, the energy ray is applied to the face exposed by the removal.

### EXAMPLES

The present invention will be described more specifically with reference to examples in the following. However, the present invention is not limited to the examples.

The properties in Examples and Comparative Examples were obtained in accordance with the following methods.

### (1) Storage Modulus of an Adhesive Layer

The storage modulus was measured at 3.5 Hz at 100 to 200° C. in accordance with the method described above using an apparatus for measuring the viscoelasticity “RHEOVIBRON DDV-II-EP” manufactured by ORIENTEC Co., Ltd. The maximum value and the minimum value in the measurement are shown in Table 1.

### (2) Blister Resistance

Display substrates for embedding pixel-controlling elements obtained in Examples 1 to 8 and Comparative Examples 1 to 3 were placed in an oven at 140° C. and taken out after 1 hour. Foaming and swelling were examined visually using a micrometer having scale marks of 1/10 mm, and the result was evaluated in accordance with the following criterion. Since the cycloolefin polymer sheet which was the thermoplastic film used in Examples 1 to 8 and Comparative Examples 1 to 3 had a glass transition temperature of 140 to 150° C., the examination of blister resistance was conducted at 140° C. excellent: no foaming or swelling at all

good: foaming and swelling smaller than 500 μm found

poor: foaming and swelling of 500 μm or greater found

### (3) Adhesive Strength

Using three samples for each of display substrates for embedding pixel-controlling elements obtained in Examples 1 to 8 and Comparative Examples 1 to 3, 24 hours after being prepared, the load of peeling was measured under the condition of 300 mm/min and 180 degree peeling using a universal tensile tester, and the average value was obtained.

Preparation Example 1 Preparation of an Adhesive in the Sheet Form for an Adhesive Layer Cured with Energy Ray

To a solution (the concentration of solid components: 35% by mass) of an acrylic ester copolymer which was obtained by the reaction of 80 parts by mass of n-butyl acrylate and 20 parts by mass of acrylic acid in a mixed solvent of ethyl acetate and methyl ethyl ketone (the ratio of the amounts by mass: 50:50), 2-methacryloyloxyethyl isocyanate was added in an amount such that the amount of the isocyanate was 30 equivalents per 100 equivalents of acrylic acid in the copolymer. The reaction was conducted at 40° C. for 48 hours under the atmosphere of nitrogen, and a copolymer curable with energy ray having a group curable with an energy ray in the side chain and having a weight-average molecular weight of about 850,000 was obtained. Into the solution of the copolymer curable with energy ray obtained above, 50 parts by mass of dimethyloltricyclodecane diacrylate [manufactured by KYOEISHA CHEMICAL Co., Ltd.; the trade name: “LIGHT ACRYLATE DCP-A”] and 20 parts by mass of an epoxy acrylate of the bisphenol A type [manufactured by KYOEISHA CHEMICAL Co., Ltd.; the trade name: “EPOXY ESTER 3000A”] as the monomers curable with energy ray, 5 parts by mass of 2,2-dimethoxy-1,2-diphenylethane-1-one [manufactured by CIBA SPECIALTY CHEMICALS Inc.; the trade name: “IRGACURE 651”] as the photopolymerization initiator and 2 parts by mass of an epoxy-based crosslinking agent [manufactured by SOKEN CHEMICAL & ENGINEERING Co., Ltd.; the trade name: “E-AX”] based on 100 parts by mass of the solid components in the solution of the copolymer curable with energy ray were dissolved. The concentration of the solid components was adjusted at 40% by mass by adding methyl ethyl ketone, and a coating fluid of a pressure sensitive adhesive curable with energy ray was prepared.

The prepared coating fluid was applied to the face treated for releasing of a release sheet of the heavy releasing type having a base sheet of polyethylene terephthalate [manufactured by LINTEC Corporation; the trade name: “SP-PET3811”] by a knife coater, and the formed coating layer was dried at 90° C. for 1 minute. Then, a release sheet of the light releasing type [manufactured by LINTEC Corporation; the trade name: “SP-PET3801”] was laminated, and an adhesive in the sheet form for an adhesive layer cured with energy ray having release sheets laminated to both faces and having a thickness of 25 μm was obtained.

Separately, one of the adhesives in the sheet form for an adhesive layer cured with energy ray having release sheets laminated to both faces and having a thickness of 25 μm obtained as described above was cut into a piece having a size of 25 mm×50 mm. The obtained piece of the adhesive in the sheet form was cured by irradiation with ultraviolet light (300 mW/cm², 150 mJ/cm²) at the side having the release sheet of the light releasing type using an apparatus for irradiation with ultraviolet light having a fusion H bulb as the light source. The obtained cured adhesive in the sheet form was further cut into a piece having a length of 30 mm and a width of 2 mm, and the storage modulus (E′) was measured in accordance with the method described above.

The results are shown in Table 1.

Preparation Example 2 Preparation of an Adhesive in the Sheet Form for an Adhesive Layer Cured with Heat

An adhesive in the sheet form for an adhesive layer cured with heat was obtained in accordance with the same procedures as those conducted in Preparation Example 1 except that 5 parts by mass of tert-butyl peroxy-2-ethylhexanoate [manufactured by NOF Corporation; the trade name: “PERBUTYL O”J] as the thermal polymerization initiator was used in place of the photopolymerization initiator used in the preparation of the coating fluid of an adhesive curable with energy ray.

Separately, one of the adhesives in the sheet form for an adhesive layer cured with heat having release sheets laminated to both faces and having a thickness of 25 μm obtained as described above was cut into a piece having a size of 25 mm×50 mm. The obtained piece of the adhesive in the sheet form was cured by placing into a thermostatted vessel at 100° C. for 30 minutes. The obtained cured adhesive in the sheet form was further cut into a piece having a length of 30 mm and a width of 2 mm, and the storage modulus (E′) was measured in accordance with the method described above.

The results are shown in Table 1.

### Preparation Example 3 Preparation of an Adhesive in the Sheet Form for Pressure Sensitive Adhesive Layer 1

Acrylic ester copolymer solution 1 containing an acrylic ester having a weight-average molecular weight of about 1,500,000 (the concentration of solid components: 15% by mass) was obtained by the reaction of 95 parts by mass of n-butyl acrylate and 5 parts by mass of acrylic acid in ethyl acetate. To the obtained Acrylic ester copolymer solution 1, 15 parts by mass of a monomer curable with energy ray [manufactured by TOA GOSEI Co., Ltd.; the trade name: “ARONIX M-315”], 0.3 parts by mass of a mixture of 1-hydroxycyclohexyl phenyl ketone and benzophenone [manufactured by CIBA SPECIALTY CHEMICALS Inc.; the trade name: “IRGACURE 500”] as the photopolymerization initiator, 2 parts by mass of tolylene diisocyanate modified with trimethylolpropane [manufactured by NIPPON POLYURETHANE INDUSTRY Co., Ltd.; the trade name: “CORONATE L”; trifunctional] as the polyisocyanate-based crosslinking agent and 0.1 part by mass of y-glycidoxypropyltrimethoxysilane [manufactured by SHIN-ETSU CHEMICAL Co., Ltd.; the trade name: “KBM-403”] as the silane coupling agent based on 100 parts by mass of the solid components in Acrylic ester copolymer solution 1 were dissolved, and a coating fluid of a pressure sensitive adhesive curable with energy ray having a concentration of solid components of 16.5% by mass was prepared.

The prepared coating fluid was applied to the face treated for releasing of a release sheet of the heavy releasing type having a base sheet of polyethylene terephthalate [manufactured by LINTEC Corporation; the trade name: “SP-PET3811] by a knife coater. The formed coating layer was dried at 90° C. for 1 minute and, then, a release sheet of the light releasing type [manufactured by LINTEC Corporation; the trade name: “SP PET3801”] was laminated. The resultant adhesive film was irradiated with ultraviolet light at the side having the release sheet of the light releasing type using an apparatus for irradiation with ultraviolet light having a fusion H bulb as the light source (300 mW/cm², 150 mJ/cm²), and an adhesive in the sheet form for Pressure sensitive adhesive 1 having release sheets laminated to both faces and having a thickness of 25 μm was obtained.

One of the adhesives in the sheet form for Pressure sensitive adhesive layer 1 having release sheets laminated to both faces obtained as described above was cut into a piece having a length of 30 mm and a width of 2 mm, and the storage modulus (E′) was measured using a test piece obtained by removing the release sheets from both faces of the piece obtained above in accordance with the method described above.

The results are shown in Table 1.

### Preparation Example 4 Preparation of an Adhesive in the Sheet Form for Pressure Sensitive Adhesive Layer 2

Acrylic ester copolymer solution 2 containing an acrylic ester having a weight-average molecular weight of about 800,000 (the concentration of solid components: 35% by mass) was obtained by the reaction of 77 parts by mass of n-butyl acrylate, 20 parts by mass of acrylic acid and 3 parts by mass of 2-hydroxyethyl acrylate in a mixed solvent of ethyl acetate and toluene (the ratio of the amounts by mass: 80:20). Into the obtained Acrylic ester copolymer solution 2, 2 parts by mass of tolylene diisocyanate modified with trimethylolpropane [manufactured by NIPPON POLYURETHANE INDUSTRY Co., Ltd.; the trade name: “CORONATE L”; trifunctional] as the polyisocyanate-based crosslinking agent based on 100 parts by mass of the solid components in Acrylic ester copolymer solution 2 was dissolved, and a coating fluid of a pressure sensitive adhesive was prepared. The prepared coating fluid was applied to the face treated for releasing of a release sheet of the heavy releasing type having a base sheet of polyethylene terephthalate [manufactured by LINTEC Corporation; the trade name: “SP-PET3811] by a knife coater. The formed coating layer was dried at 90° C. for 1 minute and, then, a release sheet of the light releasing type [manufactured by LINTEC Corporation; the trade name: “SP PET3801”] was laminated, and an adhesive in the sheet form for Pressure sensitive adhesive 2 having release sheets laminated to both faces and having a thickness of 25 μm was obtained.

One of the adhesives in the sheet form for Pressure sensitive adhesive layer 2 having release sheets laminated to both faces obtained as described above was cut into a piece having a length of 30 mm and a width of 2 mm, and the storage modulus (E′) was measured using a test piece obtained by removing the release sheets from both faces of the piece obtained above in accordance with the method described above.

The results are shown in Table 1.

### Preparation Example 5 Preparation of an Adhesive in the Sheet Form for Pressure Sensitive Adhesive Layer 3

An adhesive in the sheet form for Pressure sensitive adhesive 3 and having a thickness of 25 μm was obtained in accordance with the same procedures as those conducted in Preparation Example 4 except that 0.3 parts by mass of γ-acetoxypropyltrimethoxysilane as the silane coupling agent was further added in the preparation of a coating fluid of a pressure sensitive adhesive in Preparation Example 4.

One of the adhesives in the sheet form for Pressure sensitive adhesive layer 3 having release sheets laminated to both faces obtained as described above was cut into a piece having a length of 30 mm and a width of 2 mm, and the storage modulus (E′) was measured using a test piece obtained by removing the release sheets from both faces of the piece obtained above in accordance with the method described above.

The results are shown in Table 1.

### Example 1

From the adhesive in the sheet form for an adhesive layer cured with energy ray having release sheets laminated to both faces and having a thickness of 25 μm, which was obtained in Preparation Example 1, the release sheet of the light releasing type was removed, and a sheet of a cycloolefin polymer having a thickness of 100 μm [manufactured by OPTES Co., Ltd.; the trade name: “ZEONOR ZF-16”] as the thermoplastic film was laminated to the face exposed by the removal using a rubber roller. Then, the resultant laminate was cut into a piece having a size of 25 mm×100 mm. The release sheet of the heavy releasing type was removed, and the remaining laminate was laminated to a soda lime glass plate having a thickness of 2 mm [manufactured by N. S. G. PRECISION Co., Ltd.] as the base plate. The obtained laminate was irradiated with ultraviolet light (300 mW/cm², 150 mJ/cm²) at the side having the cycloolefin polymer using an apparatus for irradiation with ultraviolet light having a fusion H bulb as the light source to form an adhesive layer cured with energy ray, and a display substrate for embedding pixel-controlling elements was prepared.

The blister resistance and the adhesive strength of the prepared sample were obtained. The results are shown in Table 1.

### Example 2

From the adhesive in the sheet form for an adhesive layer cured with energy ray having release sheets laminated to both faces and having a thickness of 25 μm, which was obtained in Preparation Example 1, the release sheet of the light releasing type was removed, and a sheet of a cycloolefin polymer having a thickness of 100 μm [described above] as the thermoplastic film, which had been treated by corona discharge, was laminated to the face exposed by the removal using a rubber roller in a manner such that the face treated by corona discharge was brought into contact with the adhesive face of the adhesive in the sheet form. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. The obtained laminate was irradiated with ultraviolet light (300 mW/cm², 150 mJ/cm²) at the side having the cycloolefin polymer using an apparatus for irradiation with ultraviolet light having a fusion H bulb as the light source to form an adhesive layer cured with energy ray, and a display substrate for embedding pixel-controlling elements was prepared.

The blister resistance and the adhesive strength of the prepared sample were obtained. The results are shown in Table 1.

### Example 3

From the adhesive in the sheet form for an adhesive layer cured with heat having release sheets laminated to both faces and having a thickness of 25 μm, which was obtained in Preparation Example 2, the release sheet of the light releasing type was removed, and a sheet of a cycloolefin polymer having a thickness of 100 μm [described above] as the thermoplastic film was laminated to the face of the adhesive exposed by the removal using a rubber roller. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. The obtained laminate was placed in a thermostatted vessel at 100° C. for 30 minutes to form an adhesive layer cured with energy, and a display substrate for embedding pixel-controlling elements was prepared.

The blister resistance and the adhesive strength of the prepared sample were obtained. The results are shown in Table 1.

### Example 4

From the adhesive in the sheet form for Pressure sensitive adhesive layer 1 having release sheets laminated to both faces and having a thickness of 25 μm, which was obtained in Preparation Example 3, the release sheet of the light releasing type was removed, and a sheet of a cycloolefin polymer having a thickness of 100 μm [described above] as the thermoplastic film and having a gas barrier layer which comprised silicon oxide, had a thickness of 50 nm and was formed on one face of the sheet in accordance with the sputtering process was laminated to the adhesive using a rubber roller in a manner such that the face of the sheet having silicon oxide was brought into contact with the face of the adhesive in the sheet form exposed by the removal. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. In this manner, a display substrate for embedding pixel-controlling elements having Pressure sensitive adhesive layer 1 was prepared.

The blister resistance and the adhesive strength of the prepared sample were obtained. The results are shown in Table 1.

### Example 5

From the adhesive in the sheet form for Pressure sensitive adhesive layer 2 having release sheets laminated to both faces and having a thickness of 25 μm, which was obtained in Preparation Example 4, the release sheet of the light releasing. type was removed, and a sheet of a cycloolefin polymer having a thickness of 100 μm [described above] as the thermoplastic film and having a gas barrier layer which comprised silicon oxide, had a thickness of 50 nm and was formed on one face of the sheet in accordance with the sputtering process was laminated to the adhesive using a rubber roller in a manner such that the face of the sheet having silicon oxide was brought into contact with the face of the adhesive in the sheet form exposed by the removal. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. In this manner, a display substrate for embedding pixel-controlling elements having Pressure sensitive adhesive layer 2 was prepared.

The blister resistance and the adhesive strength of the prepared sample were obtained. The results are shown in Table 1.

### Example 6

A display substrate for embedding pixel-controlling elements having Pressure sensitive adhesive layer 2 was prepared in accordance with the same procedures as those conducted in Example 5 except that the thickness of the gas barrier layer comprising silicon oxide was changed to 30 nm.

The blister resistance and the adhesive strength of the prepared sample were obtained. The results are shown in Table 1.

### Example 7

A display substrate for embedding pixel-controlling elements having Pressure sensitive adhesive layer 2 was prepared in accordance with the same procedures as those conducted in Example 5 except that a gas barrier layer comprising silicon nitride was formed in place of the gas barrier layer comprising silicon oxide formed in Example 5.

The blister resistance and the adhesive strength of the prepared sample were obtained. The results are shown in Table 1.

### Example 8

From the adhesive in the sheet form for Pressure sensitive adhesive layer 3 having release sheets laminated to both faces and having a thickness of 25 μm, which was obtained in Preparation Example 5, the release sheet of the light releasing type was removed, and a sheet of a cycloolefin polymer having a thickness of 100 μm [described above] as the thermoplastic film and having a gas barrier layer which comprised silicon oxide, had a thickness of 50 nm and was formed on one face of the sheet in accordance with the sputtering process was laminated to the adhesive using a rubber roller in a manner such that the face of the sheet having silicon oxide was brought into contact with the face of the adhesive in the sheet form exposed by the removal. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. In this manner, a display substrate for embedding pixel-controlling elements having Pressure sensitive adhesive layer 3 was prepared.

The blister resistance and the adhesive strength of the prepared sample were obtained. The results are shown in Table 1.

### Comparative Example 1

From the adhesive in the sheet form for Pressure sensitive adhesive layer 1 having release sheets laminated to both faces and having a thickness of 25 μm, which was obtained in Preparation Example 3, the release sheet of the light releasing type was removed, and a sheet of a cycloolefin polymer having a thickness of 100 μm [described above] as the thermoplastic film was laminated to the face exposed by the removal using a rubber roller. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. In this manner, a display substrate for embedding pixel-controlling elements having Pressure sensitive adhesive layer 1 was prepared.

The blister resistance and the adhesive strength of the prepared sample were obtained. The results are shown in Table 1.

### Comparative Example 2

From the adhesive in the sheet form for Pressure sensitive adhesive layer 2 having release sheets laminated to both faces and having a thickness of 25 μm, which was obtained in Preparation Example 4, the release sheet of the light releasing type was removed, and a sheet of a cycloolefin polymer having a thickness of 100 μm [described above] as the thermoplastic film was laminated to the face exposed by the removal using a rubber roller. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. In this manner, a display substrate for embedding pixel-controlling elements having Pressure sensitive adhesive layer 2 was prepared.

The blister resistance and the adhesive strength of the prepared sample were obtained. The results are shown in Table 1.

### Comparative Example 3

From the adhesive in the sheet form for Pressure sensitive adhesive layer 2 having release sheets laminated to both faces and having a thickness of 25 lm, which was obtained in Preparation Example 4, the release sheet of the light releasing type was removed, and a sheet of a cycloolefin polymer having a thickness of 100 μm [described above] as the thermoplastic film and having a gas barrier layer which comprised silicon oxide, had a thickness of 20 nm and was formed on one face of the sheet in accordance with the sputtering process was laminated to the adhesive using a rubber roller in a manner such that the face of the sheet having silicon oxide was brought into contact with the face of the adhesive in the sheet form exposed by the removal. Then, the resultant laminate was cut into a piece having a size of 25 mm×100 mm. The release sheet of the heavy releasing type was removed, and the remaining laminate was laminated to a soda lime glass plate having a thickness of 2 mm [described above] as the base plate. In this manner, a display substrate for embedding pixel-controlling elements having Pressure sensitive adhesive layer 2 was prepared.

The blister resistance and the adhesive strength of the prepared sample were obtained. The results are shown in Table 1.

TABLE 1

| | | Treatment | |
|---|---|---|---|
| | | by corona | |
| | | discharge on | |
| | Gas barrier | thermoplastic | Type of adhesive |
| | layer | film | layer |
| Example 1 | none | none | adhesive layer cured with |
| | | | energy ray |
| Example 2 | none | treated | adhesive layer cured with |
| | | | energy ray |
| Example 3 | none | none | adhesive layer cured with |
| | | | heat |
| Example 4 | silicon oxide | none | Pressure sensitive |
| | 50 nm | | adhesive layer 1 |
| Example 5 | silicon oxide | none | Pressure sensitive |
| | 50 nm | | adhesive layer 2 |
| Example 6 | silicon oxide | none | Pressure sensitive |
| | 30 nm | | adhesive layer 2 |
| Example 7 | silicon nitride | none | Pressure sensitive |
| | 50 nm | | adhesive layer 2 |
| Example 8 | silicon oxide | none | Pressure sensitive |
| | 50 nm | | adhesive layer 3 |
| | | | (Pressure sensitive |
| | | | adhesive layer 2 + |
| | | | silane coupling agent) |
| Comparative | none | none | Pressure sensitive |
| Example 1 | | | adhesive layer 1 |
| Comparative | none | none | Pressure sensitive |
| Example 2 | | | adhesive layer 2 |
| Comparative | silicon oxide | none | Pressure sensitive |
| Example 3 | 20 nm | | adhesive layer 2 |

| | Storage modulus | | Adhesive |
|---|---|---|---|
| | [100~200° C.] | Blister | strength |
| | (Pa) | resistance | (N/25 mm) |
| Example 1 | 1.5 × 10⁶~3.0 × 10⁷ | excellent | 0.2 |
| Example 2 | 1.5 × 10⁶~3.0 × 10⁷ | excellent | 0.8 |
| Example 3 | 1.3 × 10⁶~2.7 × 10⁷ | excellent | 0.5 |
| Example 4 | 2.1 × 10⁵~3.5 × 10⁵ | excellent | 2.5 |
| Example 5 | 3.8 × 10⁴~6.2 × 10⁴ | excellent | 3.0 |
| Example 6 | 3.8 × 10⁴~6.2 × 10⁴ | good | 3.0 |
| Example 7 | 3.8 × 10⁴~6.2 × 10⁴ | excellent | 2.5 |
| Example 8 | 3.8 × 10⁴~6.2 × 10⁴ | excellent | 4.0 |
| Comparative | 2.1 × 10⁵~3.5 × 10⁵ | poor | 0.8 |
| Example 1 | | | |
| Comparative | 3.8 × 10⁴~6.2 × 10⁴ | poor | 0.8 |
| Example 2 | | | |
| Comparative | 3.8 × 10⁴~6.2 × 10⁴ | poor | 3.0 |
| Example 3 | | | |

It is shown by the results in Table 1 that the blister resistance was excellent in Examples 1 to 8 except in Example 6. The blister resistance in Example 6 is considered to have no problems, practically. In contrast, the blister resistance was poor in Comparative Examples 1 to 3.

When the results in Example 1 and Example 2 are compared, the adhesion between the thermoplastic film and the base plate was more excellent in Example 2. When the results in Example 5 and Example 8 are compared, the adhesion between the thermoplastic film and the base plate was more excellent in Example 8.

### INDUSTRIAL APPLICABILITY

By using the display substrate for embedding pixel-controlling element of the present invention, the display substrate in which pixel-controlling elements for controlling individual pixels for a display are embedded can be prepared with excellent quality.

1. A display substrate for embedding pixel-controlling elements comprising an adhesive layer and a thermoplastic film having a thickness of 50 to 500 mm which are laminated to a base plate successively in this order, wherein a storage modulus (E′) of the adhesive layer is 1.0×10⁶ Pa or greater at 100 to 200° C. as measured in accordance with Japanese Industrial Standard K 7244-4.

2. A display substrate for embedding pixel-controlling elements comprising an adhesive layer, a gas barrier layer and a thermoplastic film having a thickness of 50 to 500 mm which are laminated to a base plate successively in this order, wherein a storage modulus (E′) of the adhesive layer is 1.0×10⁴ Pa or greater at 100 to 200° C. as measured in accordance with Japanese Industrial Standard K 7244-4, and a thickness of the gas barrier layer is 25 nm or greater.

3. The display substrate for embedding pixel-controlling elements according to claim 2, wherein the gas barrier layer is an oxide film, a nitride film or an oxide-nitride film of silicon.

4. The display substrate for embedding pixel-controlling elements according to claim 1, wherein the adhesive layer is a pressure sensitive adhesive layer or a cured layer of a pressure sensitive adhesive curable with energy.

5. The display substrate for embedding pixel-controlling elements according to claim 1, wherein a thickness of the adhesive layer is 10 to 50 mm.

6. The display substrate for embedding pixel-controlling elements according to claim 1, wherein the adhesive layer comprises a silane coupling agent.

7. The display substrate for embedding pixel-controlling elements according to claim 1, wherein a raw material for the thermoplastic film is a polymer having an alicyclic structure.

8. The display substrate for embedding pixel-controlling elements according to claim 1, wherein the thermoplastic film has been treated by corona discharge or plasma discharge on a face at a side of the adhesive layer.

9. The display substrate for embedding pixel-controlling elements according to claim 2, wherein the adhesive layer is a pressure sensitive adhesive layer or a cured layer of a pressure sensitive adhesive curable with energy.

10. The display substrate for embedding pixel-controlling elements according to claim 2, wherein a thickness of the adhesive layer is 10 to 50 mm.

11. The display substrate for embedding pixel-controlling elements according to claim 2, wherein the adhesive layer comprises a silane coupling agent.

12. The display substrate for embedding pixel-controlling elements according to claim 2, wherein a raw material for the thermoplastic film is a polymer having an alicyclic structure.

13. The display substrate for embedding pixel-controlling elements according to claim 2, wherein the thermoplastic film has been treated by corona discharge or plasma discharge on a face at a side of the adhesive layer.

14. The display substrate for embedding pixel-controlling elements according to claim 3, wherein the adhesive layer is a pressure sensitive adhesive layer or a cured layer of a pressure sensitive adhesive curable with energy.

15. The display substrate for embedding pixel-controlling elements according to claim 3, wherein a thickness of the adhesive layer is 10 to 50 mm.

16. The display substrate for embedding pixel-controlling elements according to claim 3, wherein the adhesive layer comprises a silane coupling agent.

17. The display substrate for embedding pixel-controlling elements according to claim 3, wherein a raw material for the thermoplastic film is a polymer having an alicyclic structure.

18. The display substrate for embedding pixel-controlling elements according to claim 3, wherein the thermoplastic film has been treated by corona discharge or plasma discharge on a face at a side of the adhesive layer.
